(19) United States
(12) Patent Application Publication
(10) Pub. No.: US 2010/0179910 A1
(43) Pub. Date: Jul. 15, 2010

(54) CREATIVE WRITING BOOK SERIES WITH READER SUGGESTED STORYLINES INCORPORATED THEREIN

(76) Inventor: Jeff Dannenberg, Fort Lauderdale, FL (US)

Correspondence Address: MALIN HALEY DIMAGGIO BOWEN & LHOTA, P.A., 1936 S ANDREWS AVENUE, FORT LAUDERDALE, FL, 33316, US

(21) Appl. No.: 12/353,301

(22) Filed: Jan. 14, 2009

(51) Int. Cl. G06Q 10/00; G06Q 90/00

(52) U.S. Cl. 705/300

(57) ABSTRACT

A creative writing method including a series of books wherein each book tells a story that includes an incomplete final chapter having unresolved character and/or plot issues and wherein readers are encouraged to create and submit suggested storylines to resolve and complete the final chapter and continue the story. Submitted suggested final chapter endings are reviewed and at least one is selected for incorporation into the story. The selected submission provides the storyline upon which the story continues and is edited for print as the first chapter of the next book in the series, and the contributing reader/author gains authorship and publication credit. The method is particularly well suited for books and stories for children and teens, with stories that teach and explore moral, developmental, and educational matters. Providing the readership with an opportunity to contribute to the story by advancing plot and character issues the present invention is likely to stimulate sales resulting in widespread commercial success as compared with conventional published offerings.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to a books and storytelling and more particularly to a method for creating a storytelling book series wherein reader input is used and incorporated in the storyline.

2. Description of Related Art

Many books published are fictional stories. These stories typically feature a plot, setting, themes, and characters. The typical story includes a beginning, middle, and an end. The story starts at the “beginning,” is expanded upon in the “middle,” and finally reaches an “end.” In the “beginning” of the story main characters are introduced along with the setting. The “middle” of the story is often where characters are developed and the plot revealed, and further includes a climax to the story. The “end” is often relatively short and informs the reader of the fate of the characters and the how conflicts and other plot issues have been resolved. Books are typically written by one or more authors complete with the beginning, middle, and end portions. Once complete the work is published and made available for purchase at bookstores, retail outlets, over the Internet, by mail order, or any other suitable distribution channel.

The background art reveals various advancements in the field. For example, U.S. Pat. No. 5,306,155 issued to Koke, discloses a creative writing book to teach and encourage writing skills. The book includes a picture printed on each page without words, but with space in which the learner, typically a child, will generate writing to form a story. U.S. Pat. No. 6,126,202, issued to Scocca, discloses a book publishing kit for children which provides templates for designating drawing locations and one or more boxes designated for receiving text. U.S. Pat. No. 6,210,172, issued to Clements, discloses a storytelling book with clear loose-leaf holders so that a child can illustrate and narrate with text a story of his or her own invention. The book may be configured in an easel-like configuration with a first set of pages facing the listener and a second set of pages having corresponding information facing the reader to tell the story.

Finally, published patent application US 2004/0128619, to McCall, discloses a system for developing customer relationships with readers of a media for relating a story. The story has a title, a body, and an end, and dramatically created points of interest dispersed throughout the body. The system includes the media, a media storage device, the media being stored therein, and a customer relationship management module (CRMM). The media has at least one contact aid encoded in the body of the story proximate a point of interest. Upon a user selection, the contact aid aids in establishing a channel of communication from which the reader/viewer can interact with the CRMM regarding the point of interest. The CRMM captures information about the reader/viewer and analyzes the captured information, serving up appropriate portions of supplemental data to the reader/viewer. The contact aid is associated with an author or a character of the story. The system and method provides a systematic process for book publishing and film companies to develop relationships with their Reader/viewers. The invention recognizes that authors in traditional media create situations of high interest, and then takes advantage of these otherwise lost opportunities to cater to the desires of the Reader/viewer by providing him or her a means to communicate with the author or fictitious character, thus bring him or her into the story and customizing the reading/viewing experience to the user's needs.

The references of the background art are primarily designed to enhance the reading experience, but are each burdened with significant limitations. More particularly, the references either require too much input from the reader or allow for too little. For example, the Koke reference merely provides pictures and requires the user to invent the entire story. Similarly, the Scocca reference requires the user to prepare the drawings and text and then send the work to a third party for printing a finished hard-bound book. Clements also requires the user to create the story by providing text and illustration and merely provides a book structure that facilitates telling the story. Finally, the McCall reference merely provides a story having embedded e-mail addresses and/or a website wherein the reader may correspond with a “character” via e-mail.

As a result of the limitations present in the art, there remains a need for an improved storytelling system that encourages creative writing, story development, and authorship.

### BRIEF SUMMARY OF THE INVENTION

The present invention overcomes the limitations and disadvantages present in the art by providing a creative writing method including a series of books wherein each book tells a story that includes an unresolved storyline conclusion and wherein readers are encouraged to create and submit suggested storylines to resolve the unresolved conclusion. Submitted suggested storyline resolutions are reviewed and at least one is selected for incorporation into the story. The selected submission provides the storyline upon which the story continues and is edited for print as the first chapter of the next book in the series, and the contributing reader/author gains authorship and publication credit. The method is particularly well suited for books and stories for children and teens, with stories that teach and explore moral, developmental, and educational matters. Providing the readership with an opportunity to contribute to the story by advancing plot and character issues the present invention is likely to stimulate sales resulting in widespread commercial success as compared with conventional published offerings.

Accordingly, it is an object of the present invention to provide advancements in the field of publishing.

Another object of the present invention is to provide a creative writing method embodied in a book series that incorporate storyline suggestions from readers.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 is a flow chart illustrating a creative writing method embodied in a book series in accordance with the present invention.

### DETAILED DESCRIPTION OF THE INVENTION

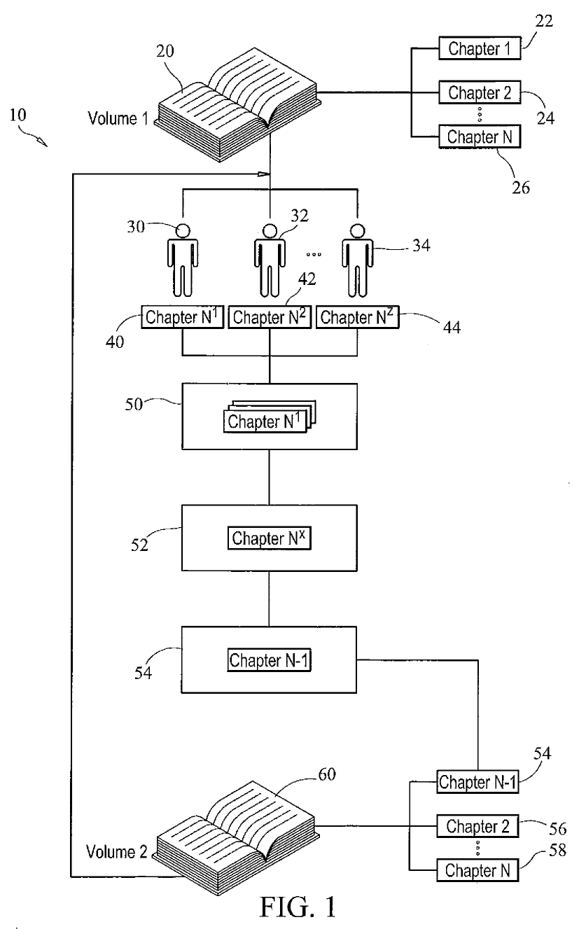

With reference now to the drawing, FIG. 1 illustrates a creative writing method, generally referenced as 10, embodied in a book series in accordance with the present invention. The present invention provides a creative writing method including a series of books wherein each book tells a story that includes an unresolved plot and/or character conclusion and wherein readers are encouraged to create and submit suggested storylines to resolve the unresolved conclusion and continue the story. Submitted suggested storyline resolutions are reviewed and at least one is selected for incorporation into the story. The selected submission provides the basis for resolving the storyline and is edited for print as the first chapter of the next book in the series. In addition, the contributing reader/author gains authorship and publication credit. The method is particularly well suited for books and stories for children and teens, with stories that teach and explore moral, developmental, and educational matters. Providing the readership with an opportunity to contribute to the story by advancing plot and character issues is likely to stimulate sales resulting in widespread commercial success as compared with conventional published offerings.

As best illustrated in FIG. 1, the method includes publishing a book series including a first book, i.e. Vol. 1, referenced as 20. Book 20 comprises a printed published work suitable for a particular age group, such as children, adolescents, young adults, adults, or older adults. In one embodiment, particularly suited for young readers book 20 includes a storyline that is educational or otherwise teaches a life lesson. The present invention, however, is easily adaptable for any suitable age group or subject matter, e.g. mystery, drama, etc. Each book includes a beginning, middle, and an end. As illustrated in FIG. 1, book 20, also identified as “Vol. 1” includes chapters 1 through N, referenced as 22, 24, and 26. For the purpose of this disclosure and as illustrated in FIG. 1, chapter 1 shall be considered the “beginning,” chapter 2 shall be considered the “middle,” and chapter N shall be considered the “end”. The term chapter is merely used herein to assist in defining a “beginning,” “middle” and “end” portions contained within a single book. It should be noted, however, that (as used herein) the “conclusion” or “end” refers to the termination of the current book/volume or final chapter and not the true end to the storyline. In the context of the present invention, the beginning and end sections of each book are considered particularly relevant. More particularly, with the exception of the first book (e.g. Vol. 1), each book “beginning” preferably opens with the storyline commencing in a generally seamless fashion picking-up where the previous volume ended or concluded following at least one reader submission. Accordingly, a significant aspect of the present invention involves providing a final chapter, namely “Chapter N,” referenced as 26, that is intentionally incomplete in that character and/or plot issues are purposefully left unresolved, e.g. unresolved conclusion(s).

As illustrated in FIG. 1, a plurality of readers, referenced as 30, 32, and 34, represent a readership of any number of book purchasers or readers. Each reader 30-34 is in possession of, and reads, a book 20. In a preferred embodiment, each book 20 is marked with and identified by the publisher with a unique serial number (not shown). As noted above, the final chapter 26 is incomplete and fails to resolve significant character and/or plot issues. The unresolved conclusion(s) provides readers with an opportunity to exercise creative thought and writing skills in formulating plot and/or character storyline resolutions. Accordingly, an opportunity is presented to the readers to use imagination and creativity to create suggested storylines, referenced as 40, 42, and 44, wherein the intentionally unresolved conclusions are completed and resolved thereby allowing the story to continue.

Readers 30-34 submit the suggested storylines 40-44 which they have created to a central repository 50 established by the publishing entity. The storylines submitted preferably pick-up at Chapter N and continues to resolve unresolved plot and/or character issues. The suggested storylines may be submitted via U.S. mail, electronic mail, or by any other suitable means. Received submissions are reviewed and evaluated, preferably by a review committee, and one submission, referenced as 52, is selected for incorporation into the storyline. Selected submission 52 may be revised and edited as deemed necessary for integration within the story. The revised and edited chapter N-1, referenced as 54, forms the opening chapter, chapter N-1, for the next book in the series, e.g. Vol. 2, referenced as 60 as illustrated in FIG. 1. In accordance with the present invention, and similar to book 20, book 60 opens with chapter N-1, referenced as 54, and continues with additional chapters 56, ultimately ending with an “end” chapter 58, which is intentionally incomplete in that character and/or plot issues are purposefully left unresolved. This provides another opportunity for readers to use imagination and creativity to create suggested storylines to complete the final chapter by creatively resolving plot and character issues. The author of selected storyline submission 52 is credited as a co-author of book 60, e.g. Vol. 2. This provides the reader/co-author with authorship credit as to a published work thereby providing an incentive for the readers to contribute creative and diverse storyline suggestions. As should now be apparent, the present invention provides a virtually endless method of obtaining storyline ideas from readers which encourages reader loyalty to the series.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A method of publishing books having storylines incorporating reader authored contribution, said method including the steps of:
(a) publishing a first book, said first book containing a story with an unresolved conclusion;
(b) soliciting the submission of suggested storylines from readers, said storylines directed resolving said unresolved conclusion;
(c) receiving submissions of suggested storylines authored by readers;
(d) selecting a suggested storyline for incorporation into said story from said received submissions;
(e) revising said first book unresolved conclusion by incorporating the selected suggested storyline to create a resolved conclusion; and
(f) publishing a second book, said second book containing a story that begins with said resolved conclusion.

2. A method according to claim 1, wherein said first book comprises a children's book.

3. A method according to claim 1, further including the step of providing co-authorship credit to the author of said selected suggested storyline with said second book.

4. A method according to claim 1, including repeating steps (a) (f) for a plurality of books.

5. A method of publishing books having storylines incorporating reader input, said method including the steps of:
(a) publishing a first book, said first book containing a story with an unresolved conclusion including unresolved plot and/or character issues, said book comprising a children's book with story relating a life lesson;
(b) inviting readers to prepare and submit storyline ideas for resolving said plot and/or character issues;
(c) receiving submissions of suggested storylines authored by readers;
(d) selecting at least one received suggested storyline for incorporation into said story from said received submissions;
(e) revising said story unresolved conclusion by incorporating at least one selected suggested storyline to create a resolved conclusion; and
(f) publishing a second book, said second book containing a story that begins with said complete end.

6. A method according to claim 5, further including the step of providing co-authorship credit to the author of said selected suggested storyline with said second book.

7. A method according to claim 5, including repeating steps (a)-(f) for a plurality of books.
